(19) United States
(12) Patent Application Publication
(10) Pub. No.: US 2024/0410530 A1
(43) Pub. Date: Dec. 12, 2024

(54) FREEZER AND FREEZER SYSTEM

(71) Applicant: IC BIOMEDICAL, LLC, Cartersville, GA (US)

(72) Inventors: Edward Lee Thomas, Gainesville, GA (US); Christopher Warren Fortenberry, Canton, GA (US)

(21) Appl. No.: 18/330,136

(22) Filed: Jun. 6, 2023

(51) Int. Cl. F17C 13/04; F17C 13/00

(52) U.S. Cl. CPC F17C 13/04; F17C 13/001; F17C 2203/0391; F17C 2205/0302; F17C 2223/0161

(57) ABSTRACT

A freezer system that uses liquid cryogen as a refrigerant for a freezer. The freezer includes an inner vessel defining a storage chamber and a vapor space, an outer shell that surrounds and is separated from the inner vessel to define an insulation space between the inner vessel and the outer shell, and an access opening extending between the outer shell and inner vessel to facilitate the insertion and removal of samples. An atomizing nozzle is positioned within the vapor space and is configured to receive a flow of liquid cryogen and to produce a flow of atomized liquid cryogen that vaporizes within the vapor space to thereby cool the vapor space. A controller is configured to control the flow of liquid cryogen to the freezer.

### FIELD

The present disclosure relates generally to a freezer system, and, more particularly, to a freezer system with an atomizing nozzle that uses a liquid cryogen to enable more precise temperature control of a freezer.

### BACKGROUND

Cryogenic freezers have been used to store biological materials. Cryogenic freezers have been used for immersion storage of materials in a pool of liquid cryogen and for vapor phase storage above a pool of liquid cryogen. Liquid cryogen immersion storage freezers, such as described in U.S. Pat. No. 3,088,787, use a pool of liquid cryogen to cool a freezer. However, conventional storage freezers may be more difficult to regulate, which may result in warming and thawing of the contents stored therein.

Vapor phase cryogen freezers may reduce the possibility of contaminating biological materials stored in the freezer. Vapor phase cryogen freezers include a pool of liquid cryogen at the bottom of the freezer and boil off vapor from the pool of liquid cryogen is used at a top portion of the freezer to maintain a cold temperature in the freezer. However, heat rising from the liquid cryogen pool may result in thermal stratification of the freezer. As a result, materials stored near the bottom of the freezer, nearer the cryogen pool may be colder than materials at the top of the freezer, such as closer to an access opening of the freezer.

Beyond warmer storage temperatures, changes in temperature may also adversely affect biological materials stored in a freezer. For example, the temperature within a freezer may cycle due to warming and subsequent cooling operations, such as the addition of cryogen into the freezer. The cycling of temperatures within the freezer may causes biological materials stored therein to expand and contract.

The temperature within both liquid cryogen immersion storage freezers and vapor phase storage freezers using a pool of liquid cryogen may be difficult to regulate for a variety of reasons. First, whenever heat is introduced into the freezer, such as by opening a lid or inserting materials into the freezer, local heating of the freezer occurs. Opening the lid of the freezer causes warming of the freezer based upon the surrounding environment. Additionally, placing warmer materials into the freezer will also increase the temperature in the freezer. The added materials may warm surrounding materials and/or the liquid cryogen. The added materials may heat the surrounding vapor space, which may rise to the top of the freezer. The increase in heat may warm the materials in the freezer, which may then cool again over a period of time in the freezer. As a result, biological materials stored in the freezer, particularly materials stored in the uppermost part of the freezer, may experience temperature cycling.

Freezers including pools of liquid cryogen may also be difficult to regulate due to the pool of liquid cryogen itself. The liquid cryogen temperature may maintain cold temperatures, such as temperatures below −190° C. Certain biological materials, such as vaccines, blood, and tissues can be damaged at cryogenic storage temperatures, or have shorter term storage requirements than other materials. Freezers for such materials may need to be operated at warmer storage temperatures, such as −80° C. or higher. Accordingly, cryogenic freezers are often unsuited for storage of such biological materials.

Finally, conventional cryogenic freezers may be slow to respond to changes in temperature, such as fluctuations in temperature. After a rise in freezer temperature, it may take time for additional cryogen to cool the freezer such that the freezer continues to warm. Generally, after the temperature cools down, the additional cryogen continues to cool the freezer, causing the freezer to fall below a desired temperature. The resulting temperature cycling may be about 15° C. each cycle, thus stressing the biological materials stored therein.

Therefore, there is a desire for a cryogenic freezer which more efficiently regulates temperature within the freezer, such as near a constant desired temperature.

### SUMMARY

Disclosed herein is a freezer system with a freezer that uses a liquid cryogen as a refrigerant and that is useful for the storage of temperature sensitive materials. To illustrate various aspects of the present disclosure, exemplary embodiments of a freezer are provided herein.

In one embodiment, a cryogenic freezer system is provided. The freezer system includes a liquid cryogen supply system with a supply of liquid cryogen, a freezer supply control valve, and a bottom fill control valve. The freezer system also includes a freezer having an inner vessel defining a storage space and a vapor space, an outer shell that surrounds and is separated from the inner vessel to define an insulation space between the outer shell and the inner vessel, and a liquid cryogen atomizing nozzle positioned within the vapor space and configured to receive a flow of liquid cryogen and to produce a flow of atomized liquid cryogen that vaporizes within the vapor space to thereby cooling the vapor space. The freezer supply control valve is configured to operatively control a flow of liquid cryogen to the liquid cryogen atomizing nozzle. The bottom fill control valve is configured to operatively control a flow of liquid cryogen to a bottom portion of the inner vessel.

In one embodiment, a method performed by a controller of a freezer system is provided. The method includes the steps of generating an output indicative of a vapor space of a freezer exceeding a maximum temperature, opening a freezer supply control valve, dispensing cryogen into the vapor space of the freezer via a liquid cryogen atomizing nozzle, and determining a temperature of the vapor space being below the desired temperature. In some embodiments, the method includes the steps of opening a gas bypass control valve, determining a temperature of a liquid cryogen supply line to be below a predetermined temperature, and closing the gas bypass control valve. In some embodiments, the method also includes the step of closing the freezer supply control valve.

In one embodiment, a method performed by a controller of a freezer system is provided. The method includes the steps of generating an output indicative of a level of liquid cryogen in a freezer being below a minimum level, opening a bottom fill control valve, providing liquid cryogen to the freezer, and determining the level of liquid cryogen in the freezer to be above the desired level. In some embodiments, the method includes the steps of opening a gas bypass control valve, determining a temperature of a liquid cryogen supply line to be below a predetermined temperature, and closing the gas bypass control valve. In some embodiments, the method includes the steps of opening a freezer supply control valve and dispensing cryogen into the vapor space of the freezer via liquid cryogen atomizing nozzle. In some embodiments, the method includes the step of determining a temperature of the vapor space being below the desired temperature. In some embodiments, the method also includes the step of closing the bottom fill control valve and the freezer supply control valve.

In one embodiment, a freezer system is provided. The freezer system includes a liquid cryogen supply system having a supply of liquid cryogen and a freezer supply control valve. The freezer system also includes a freezer having an inner vessel defining a storage space and a vapor space, an outer shell that surrounds and is separated from the inner vessel to define an insulation space between the outer shell and the inner vessel, and a liquid cryogen atomizing nozzle positioned within the vapor space and configured to receive a flow of liquid cryogen and to produce a flow of atomized liquid cryogen that vaporizes within the vapor space to thereby cooling the vapor space. The freezer system also includes a controller with a freezer control system having programmed instructions configured to operate the freezer supply control valve to control a temperature in the vapor space. The freezer supply control valve is configured to operatively control a flow of liquid cryogen to the liquid cryogen atomizing nozzle.

In one embodiment, a freezer system is provided. The freezer system includes a liquid cryogen supply system having a supply of liquid cryogen, a freezer supply control valve, and a bottom fill control valve. The freezer system also includes a freezer having an inner vessel defining a storage space and a vapor space, an outer shell that surrounds and is separated from the inner vessel to define an insulation space between the outer shell and the inner vessel, and a liquid cryogen atomizing nozzle positioned within the vapor space and configured to receive a flow of liquid cryogen and to produce a flow of atomized liquid cryogen that vaporizes within the vapor space to thereby cooling the vapor space. The freezer system also includes a controller with a freezer supply control valve having programmed instructions configured to operate the freezer supply control valve and the bottom fill control valve to control a level of liquid cryogen in a bottom portion of the vessel. The freezer supply control valve is configured to operatively control a flow of liquid cryogen to the liquid cryogen atomizing nozzle. The bottom fill control valve is configured to operatively control a flow of liquid cryogen to the bottom portion of the vessel.

In one embodiment, a system for cooling a freezer is provided. The system includes a supply of liquid cryogen, a freezer supply control valve, a liquid cryogen atomizing nozzle, and a controller. The liquid cryogen atomizing nozzle is positioned within the freezer and is configured to receive a flow of liquid cryogen to produce a flow of atomized liquid cryogen that vaporizes within the freezer to thereby cool the freezer. The controller is configured to control the flow of liquid cryogen through the freezer supply control valve to the liquid cryogen atomizing nozzle.

Other aspects, advantages, and features of the inventive concepts of the present disclosure will become apparent to those skilled in the art from the following detailed description, when read in light of the accompanying drawings.

### BRIEF DESCRIPTION OF DRAWINGS

To further clarify various aspects of implementations of the present disclosure, a more particular description of the certain examples and implementations will be made by reference to various aspects of the appended drawings. These drawings depict only example implementations of the present disclosure and are therefore not to be considered limiting of the scope of the disclosure. Moreover, while the Figures can be drawn to scale for some examples, the Figures are not necessarily drawn to scale for all examples. Examples and other features and advantages of the present disclosure will be described and explained with additional specificity and detail through the use of the accompanying drawings in which:

FIG. 1 is a schematic illustration of an exemplary freezer system of the present disclosure;

FIG. 2 is a functional block diagram of a controller;

FIG. 3 is an illustrative example depicting a methodology for controlling a temperature in a freezer of the freezer system of FIG. 1;

FIG. 4 is an illustrative example depicting a methodology for controlling a liquid cryogen level in a freezer of the freezer system of FIG. 1;

FIG. 5 is a schematic illustration of another exemplary freezer system of the present disclosure;

FIG. 6 is a schematic illustration of another exemplary freezer system of the present disclosure;

FIG. 7 is a schematic illustration of another exemplary freezer system of the present disclosure; and

FIG. 8 is a schematic view of an exemplary freezer system of the present disclosure.

### DETAILED DESCRIPTION

Disclosed herein is a freezer system that uses a liquid cryogen as a refrigerant for a freezer. The freezer is useful for storing temperature sensitive materials, such as biological materials including, but not limited to, live cells, vaccines, semen, eggs, embryos, infectious substances, and so forth. While the present disclosure describes certain embodiments of the foregoing devices in detail, the present disclosure is to be considered exemplary and is not intended to be limited to the disclosed embodiments.

Conventional freezers and freezer systems that use a liquid cryogen as a refrigerant may have imprecise temperature control and/or slow responses to temperature changes within the freezer. Moreover, conventional freezers and freezer systems that use a liquid cryogen as a refrigerant do not allow for precise temperature control at temperatures that are significantly above cryogenic storage temperatures (e.g., −80° C. or higher).

Because there is a correlation between the storage temperature and the long-term viability of the stored material, conventional freezers and freezer systems are designed to minimize thermal stratification by using efficient insulation systems and a small access opening to minimize incoming heat, as well as using thermally conductive materials within the inner vessel to conduct the incoming heat to the bottom of the freezer or directly to the liquid cryogen pool. However, conventional freezers and freezer systems still have imprecise temperature control and slow response times. Additionally, conventional freezers and freezer systems may have temperature cycling issues.

The freezer systems of the present disclosure solve the above-mentioned problems associated with conventional freezers and freezer systems that utilize a liquid cryogen as a refrigerant, including both conventional liquid immersion type freezers and conventional vapor phase storage type freezers. In particular, the problems are solved by incorporating a liquid cryogen atomizing nozzle that provides a mist of liquid cryogen into a vapor space of the freezer to provide precise temperature control and a rapid response to temperature changes.

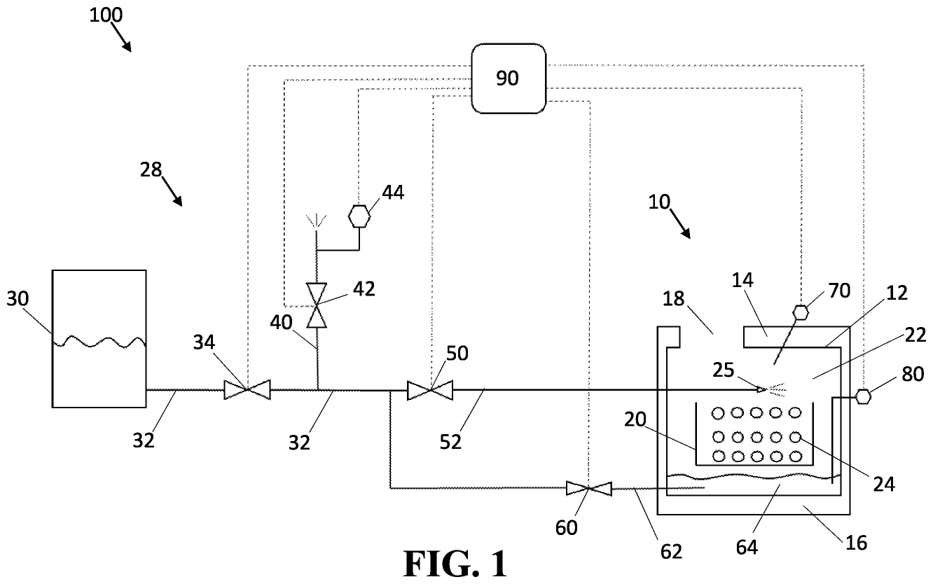

Referring now to FIG. 1, a freezer system 100 with a freezer 10 according to the present disclosure is illustrated. The freezer 10 includes an inner vessel 12 that defines a storage space 20 and a vapor space 22. The storage space 20 is configured to retain one or more samples 24. The samples 24 may be temperature sensitive materials, such as biological materials including, but not limited to, live cells, vaccines, semen, eggs, embryos, infectious substances, and so forth. The freezer 10 may be any suitable type of freezer or container for maintaining a cool temperature. For example, the freezer 10 may be a high-efficiency cryogenic freezer, a mechanical refrigeration system, or the like.

An outer shell 14 generally surrounds and is separated from the inner vessel 12 to define an insulation space 16 between the inner vessel 12 and the outer shell 14. In certain aspects, a vacuum is drawn on the insulation space 16 to insulate the freezer 10. Alternatively, in certain aspects, the insulation space 16 may be filled with other insulation materials such as, for example, a foam insulation, a fiberglass insulation, or an aerogel insulation, or a combination thereof.

With continued reference to FIG. 1, the freezer 10 includes a liquid cryogen atomizing nozzle 25 that is positioned within the vapor space 22 of the freezer 10. The liquid cryogen atomizing nozzle 25 is configured to receive a flow of liquid cryogen and to produce a flow of atomized liquid cryogen that vaporizes within the vapor space 22, thereby cooling the vapor space 22. In certain aspects, the liquid cryogen atomizing nozzle 25 is positioned and/or oriented so that the cryogen flowing therefrom is directed away from the samples 24 disposed in the storage space 20 to prevent the samples 24 from getting sprayed with the liquid cryogen.

The freezer 10 also includes an access opening 18 between the inner vessel 12 and the outer shell 14. The access opening 18 permits user access to the storage space 20 for inserting and removing samples 24. An insulated plug, door, or lid (not shown) is used to cover the access opening 18 when not inserting or removing samples 24. The storage space 20 may include one or more rotatable trays and/or racks (not shown) to hold the samples 24. In certain aspects, the liquid cryogen atomizing nozzle 25 is positioned and/or oriented so that the cryogen flowing therefrom is directed away from the access opening 18 to prevent persons working the freezer 10 from getting sprayed with liquid cryogen.

The freezer 10 can be connected to a liquid cryogen supply system 28 that includes a supply of liquid cryogen 30 that is fluidly connected to the freezer 10 via one or more lines and one or more flow control devices (e.g., valves). The liquid cryogen supply system 28 may be connected to the freezer 10 as the primary cooling mechanism for the freezer 10 or the liquid cryogen supply system 28 may be connected to the freezer 10 as a secondary or backup cooling mechanism, such as to provide backup or assistance cooling to a freezer with a mechanical refrigeration system.

As seen in FIG. 1, the liquid cryogen supply system 28 includes a liquid cryogen supply line 32 is fluidly connected to the supply of liquid cryogen 30. A liquid supply valve 34 may be positioned in or along the liquid cryogen supply line 32 to control the flow of liquid cryogen from the supply of liquid cryogen 30 to the freezer 10. The liquid supply valve 34 may be a manual valve or an automated valve positioned. The liquid supply valve 34 may be disposed along a length of the liquid cryogen supply line 32 or at an outlet of a vessel holding the supply of liquid cryogen 30. Typically, the liquid supply valve 34 remains in an open position to permit the flow of liquid cryogen. However, the liquid supply valve 34 may be placed in a close position such that liquid cryogen is not permitted to flow from the supply of liquid cryogen 30 to downstream portions of the liquid cryogen supply line 32.

In certain aspects, the freezer system 100 includes at least two control valves. As seen in FIG. 1, the freezer system 100 includes a gas bypass line 40 that is fluidly connected to the liquid cryogen supply line 32. A gas bypass control valve 42 is positioned in or along the gas bypass line 40 and is configured to vent warm gas to the atmosphere, such as until the liquid cryogen supply line 32 cools to a desired temperature.

With continued reference to FIG. 1, the freezer system 100 includes a freezer supply control valve 50 that is fluidly connected to the liquid cryogen supply line 32 at an upstream end and fluidly connected to a freezer supply line 52 at a downstream end. The freezer supply control valve 50 is connected to the liquid cryogen supply line 32 downstream of where the gas bypass line 40 is fluidly connected to the liquid cryogen supply line 32 and is configured to direct the flow of liquid cryogen to the freezer 10 via the freezer supply line 52. The freezer supply control valve 50 may be moved between a closed position in which liquid cryogen is prevented from flowing from the liquid cryogen supply line 32 to the freezer supply line 52 and an open position in which liquid cryogen may flow from the liquid cryogen supply line 32 to the freezer supply line 52. A downstream end of the freezer supply line 52 is fluidly connected to the liquid cryogen atomizing nozzle 25. Accordingly, when the liquid supply valve 34 and the freezer supply control valve 50 are in an open position and the gas bypass control valve 42 is in a closed position, liquid cryogen flows from the supply of liquid cryogen 30 through the liquid cryogen atomizing nozzle 25 into the vapor space 22 of the freezer 10, thereby cooling the vapor space 22.

In certain aspects, the freezer system 100 includes at least three control valves. In addition to a gas bypass control valve 42 and a freezer supply control valve 50, the freezer system 100 may further include a bottom fill control valve 60, as shown in FIG. 1. The bottom fill control valve 60 is fluidly connected to the liquid cryogen supply line 32 at an upstream end and to a bottom fill line 62 at a downstream end. The bottom fill control valve 60 may be fluidly connected to the liquid cryogen supply line 32 upstream of the freezer supply control valve 50. The bottom fill line 62 is fluidly connected to a bottom space of the inner vessel 12, which retains a pool of liquid cryogen 64. The bottom fill control valve 60 may be moved between a closed position in which liquid cryogen is prevented from flowing from the liquid cryogen supply line 32 to the bottom fill line 62 and an open position in which liquid cryogen may flow from the liquid cryogen supply line 32 to the bottom fill line 62. Accordingly, when the liquid supply valve 34 and the bottom fill control valve 60 are in an open position and the gas bypass control valve 42 is in a closed position, liquid cryogen flows from the supply of liquid cryogen 30 through the bottom fill line 62 into the bottom space of the freezer 10 thereby cooling the freezer 10 via the pool of liquid cryogen 64 in the bottom space of the inner vessel 12.

The freezer supply control valve 50 and the bottom fill control valve 60 may be fluidly connected to the liquid cryogen supply line 32 such that liquid cryogen may be supplied to one or both of the atomizing nozzle 25 and the pool of liquid cryogen 64 or prevented from flowing to the atomizing nozzle 25 and pool of liquid cryogen 64. The freezer supply control valve 50 and the bottom fill line 62 may be independently controlled to control the flow of liquid cryogen to the freezer 10. When the liquid supply valve 34 and the bottom fill control valve 60 are in the open position and the gas bypass control valve 42 and the freezer supply control valve 50 are in the closed position, liquid cryogen flows from the supply of liquid cryogen 30 through the liquid cryogen supply line 32 to the bottom fill line 62 and to the pool of liquid cryogen 64, thereby cooling the freezer 10 via the pool of liquid cryogen 64 in the bottom space of the inner vessel 12. When the liquid supply valve 34 and the freezer supply control valve 50 are in the open position and the gas bypass control valve 42 and the bottom fill control valve 60 are in the closed position, liquid cryogen flows from the supply of liquid cryogen 30 through the liquid cryogen supply line 32 to the freezer supply line 52, through the liquid cryogen atomizing nozzle 25, and into the vapor space 22 of the freezer 10, thereby cooling the freezer 10 via the atomized liquid cryogen that is injected into the vapor space 22. When the liquid supply valve 34, the freezer supply control valve 50, and the bottom fill control valve 60 are in the open position and the gas bypass control valve 42 is in the closed position, liquid cryogen flows from the supply of liquid cryogen 30 through the liquid cryogen supply line 32 and both to the freezer supply line 52 and to the bottom fill line 62 such that liquid cryogen flows through the liquid cryogen atomizing nozzle 25 into the vapor space 22 of the freezer 10 and through the bottom fill line 62 into the pool of liquid cryogen 64, thereby cooling the freezer 10 via the pool of liquid cryogen 64 in the bottom space of the inner vessel 12 as well as via the atomized liquid cryogen that is injected into the vapor space 22.

While the freezer system 100 has been described as including a bottom fill control valve 60, a bottom fill line 62, and a pool of liquid cryogen 64, it will be understood that the freezer system 100 and/or the freezer 10 may have other configurations. For example, the freezer system 100 may not include the bottom fill control valve 60, the bottom fill line 62, and/or the pool of liquid cryogen 64, such as in embodiments when the freezer 10 is configured to operate at higher temperatures, such as at or above −80° C.

The freezer system 100 may include one or more sensing devices. In certain aspects, the freezer system 100 includes at least two sensing devices. As seen in FIG. 1, the freezer system 100 includes a gas bypass temperature sensor 44 that is in communication with the liquid cryogen supply line 32 and positioned downstream of the gas bypass control valve 42. The gas bypass temperature sensor 44 senses the temperature of the liquid cryogen within the liquid cryogen supply line 32 at a point upstream of the freezer supply line 52 and the bottom fill line 62. The gas bypass temperature sensor 44 may be configured to generate an output indicative of a temperature in the liquid cryogen supply line 32. While the gas bypass temperature sensor 44 has been described as being downstream of the gas bypass control valve 42, it will be understood that the gas bypass temperature sensor 44 may be positioned upstream of the gas bypass line 40 and/or the gas bypass control valve 42 such that it may sense the temperature of the liquid cryogen within the liquid cryogen supply line 32 at a point upstream of freezer control line 52 and the bottom fill line 62.

With continued reference to FIG. 1, the freezer system 100 includes a vapor space temperature sensor 70 positioned in the vapor space 22 of the inner vessel 12 of the freezer 10. The vapor space temperature sensor 70 is configured to sense a temperature of the vapor space 22 of the inner vessel 12 at an upper portion thereof. In certain aspects, the vapor space temperature sensor 70 is positioned above the storage space 20 and within the vapor space 22 of the inner vessel 12 and, thus, senses the temperature of the vapor space 22 above the storage space 20. The vapor space temperature sensor 70 may be configured to generate an output indicative of the temperature of the vapor space 22 of the inner vessel 12 as the upper portion thereof.

The gas bypass temperature sensor 44 and the vapor space temperature sensor 70 may be any type of conventional temperature sensor or probe that is suitable for use in cryogenic freezer applications. In certain aspects, the liquid cryogen atomizing nozzle 25 is positioned within the vapor space 22 so that the cryogen flowing therefrom is directed away from the vapor space temperature sensor 70 so that the sensor 70 accurately measures the temperature of the vapor space 22 above the storage space 20.

In certain aspects, the freezer system 100 includes at least three sensing devices. In addition to a gas bypass temperature sensor 44 and a vapor space temperature sensor 70, the freezer system 100 may further include a liquid level sensor 80, as shown in FIG. 1. The liquid level sensor 80 is positioned within the inner vessel 12 of the freezer 10 and senses a height or level of the pool of liquid cryogen 64 in the bottom space of the inner vessel 12. The liquid level sensor 80 may be any type of conventional level sensor or indicator that is suitable for use in cryogenic freezer applications. The liquid level sensor 80 may be configured to generate an output indicative of the height of the pool of liquid cryogen 64 in the bottom space of the inner vessel 12. In other embodiments, the freezer system 100 may not include a liquid level sensor 80, such as when the freezer 10 does not include a pool of liquid cryogen 64.

In certain aspects, the freezer system 100 includes an electronic controller 90 that is in communication with the valves 34 (if automated), 42, 50, 60 and sensors 44, 70, 80. The controller 90 may be in communication with the valves 34, 42, 50, 60 and sensors 44, 70, 80 directly, such as via wires, Bluetooth, or the like, or indirectly, such as via a network, the Internet, or the like. The controller 90 may also be in communication with other components of the freezer system 100. For example, the controller 90 may be in communication with the one or more rotatable trays and/or racks (not shown) that hold the samples 24.

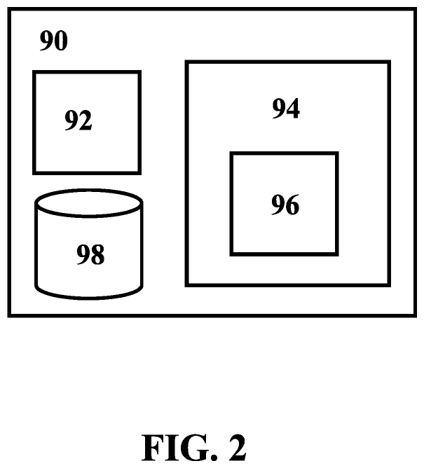

The controller 90 may be a microprocessor, or any other electronic control device known in the art. As shown in FIG. 2, the controller 90 may include at least one processor 92 that executes instructions that are stored in a memory 94. The memory 94 has a freezer control system 96 loaded therein that is configured to control the operations and flow of cryogen in the freezer 10, such as based upon the outputs generated by the sensors 44, 70, 80. The controller 90 may also include a data store 98 in communication with the processor 92, where the data store 98 can include historical operating temperatures, preset temperature values, and preset fluid levels. The controller 90 may be configured to receive outputs from the sensors 44, 70, 80 as inputs. The freezer control system 96 may be configured to output a command to one or more valves based upon the outputs of one or more sensors 44, 70, 80 in the system. The freezer control system 96 may be configured to output a command to open or close one or more valves 42, 50, 60 in the system based upon one or more sensed temperatures and/or one or more sensed fluid levels. For example, the controller 90 may control the action of the control valves 42, 50, 60 in response to signals received from the sensors 44, 70, 80 to control the temperature of the freezer 10, the liquid level of the pool of liquid cryogen 64 in the freezer 10, or both. The controller 90 may also be configured to output a command to control the movement of the one or more rotatable trays and/or racks (not shown) that hold the samples 24. For example, the controller 90 may output a command to one or more motors to rotate, stop rotating, or control the rotation of the one or more rotatable trays and/or racks.

The freezer control system 96 of the controller 90 may be configured or programmed to control an operation of the freezer system 100. In some embodiments, the freezer control system 96 of the controller 90 may be configured or programmed for different modes of operation that control two freezer parameters. A first operating mode is a temperature control mode that controls the temperature of the vapor space 22 of the inner vessel 12 (e.g., the vapor space 22 above the storage space 20 that holds the one or more samples 24). A second operating mode is a level control mode that controls a height or level of the pool of liquid cryogen 64 in the bottom space of the freezer 10. In certain aspects, if both operating modes are enabled, the controller 90 may be configured such that the level control mode will take precedence over the temperature control mode. The freezer control system 96 or the controller 90 may include preset desired temperature in the liquid cryogen supply line 32, preset minimum and/or maximum desired temperatures of the vapor space 22, and preset minimum and/or maximum desired heights of the pool of liquid cryogen 64 in the bottom space of the inner vessel 12, such as input by a user. It will be understood that the freezer control system 96 may be configured to operate in one or both of the temperature control mode and the level control mode.

The controller 90 may be configured to control the operation of the freezer system 100 based upon the preset values and/or the outputs of one or more of the sensors 44, 70, 80. When the temperature of the vapor space 22 sensed by the vapor space temperature sensor 70 is at or below a setpoint temperature programmed into the controller 90, such as below the preset minimum temperature, and the liquid level of the pool of liquid cryogen 64 sensed by the liquid level sensor 80 is at or above the setpoint level programmed into the controller 90, such as above the preset minimum level, the controller 90 may be configured to generate an output indicative of the freezer 10 being in normal operation. For example, based upon the outputs of the sensors 70, 80, the controller 90 may generate may determine that the vapor space 22 is sufficiently cool and the level of the liquid cryogen 64 is sufficiently high. The controller 90 may then generate a command signal which causes the control valves 42, 50, 60 to be moved into or kept in the closed position, such as to prevent the flow of liquid cryogen into the freezer 10.

When the controller 90 is in level control mode or if both level control mode and temperature control mode are enabled, the following sequence will occur. When the liquid level of the pool of liquid cryogen 64 sensed by the liquid level sensor 80 is or falls below a predetermined setpoint level programmed into the controller 90, such as below the preset minimum level, the controller 90 may generate an output indicative of insufficient liquid cryogen 64 in the inner vessel 12. The controller 90 may then generate output commands to control the operations of the freezer 10. First, in some embodiments, the controller 90 may generate an output command causing the gas bypass control valve 42 to move to the open position to direct the flow of cryogen from the liquid cryogen supply line 32 through the gas bypass line 40 to the atmosphere outside of the freezer 10. The gas bypass control valve 42 may remain open and the temperature measured by the gas bypass temperature sensor 44 may be provided to the controller 90 as input. When the temperature sensed by the gas bypass temperature sensor 44 is below a desired temperature, the controller 90 generates an output command causing the gas bypass control valve 42 to close and the freezer supply control valve 50 to open. For example, the controller 90 may cause the gas bypass control valve 42 to close and the freezer supply control valve 50 to open when a temperature measured by the gas bypass temperature sensor 44 is less than a predetermined setpoint temperature programmed into the controller 90. Liquid cryogen may then flow from the liquid cryogen supply line 32 through the freezer supply line 52 to the liquid cryogen atomizing nozzle 25 and into the vapor space 22 above the storage space 20 in the freezer 10. In other embodiments, the controller 90 may generate an output command which causes the freezer supply control valve 50 to open without first venting liquid cryogen from the gas bypass control valve 42.

The lines 32, 52 and valves 34, 50 may be configured and sized to allow for a much greater volume of fluid flow than the liquid cryogen atomizing nozzle 25. The lines 32, 52 and valves 34, 50 may also be configured and sized such that the liquid cryogen atomizing nozzle 25 is the flow restriction in the system. When the liquid cryogen atomizing nozzle 25 is the flow restriction in the system, the liquid cryogen may maintain its saturation pressure until it reaches the liquid cryogen atomizing nozzle 25, which may cause the liquid cryogen exiting the nozzle 25 to rapidly expand and partially flash to vapor within the vapor space 22 of the freezer 10. The liquid cryogen flashing to vapor may cause any remaining liquid exiting the nozzle 25 to be broken up into microscopic droplets, which increases the surface area of the liquid cryogen in contact with the vaporized cryogen in the vapor space 22. The increased surface area of the liquid cryogen droplets, the heat of vaporization of the liquid cryogen, and the forced convection from the liquid cryogen atomizing nozzle 25 may cause rapid cooling of the vapor space 22. After the temperature of the vapor space 22 as measured by the vapor space temperature sensor 70 stabilizes or is below a desired temperature (i.e., is equal to the temperature of the incoming liquid cryogen as measured by the gas bypass temperature sensor 44), the controller 90 generates an output command which causes the bottom fill control valve 60 to open. As a result, liquid cryogen is permitted to flow from the liquid cryogen supply line 32 through the bottom fill line 62 and into the pool of liquid cryogen 64 in the bottom space of the freezer 10. Although liquid cryogen will continue to flow in parallel through the nozzle 25 into the vapor space 22 (when the freezer supply control valve 50 is open), the unrestricted fluid flow through the bottom fill control valve 60 and bottom fill line 62 will cause the majority (e.g., more than 50%) of the liquid cryogen to flow directly into the pool of liquid cryogen 64. Liquid cryogen may flow from the bottom fill line 62 into the pool of liquid cryogen 64 until a desired minimum level of cryogen is achieved. While liquid cryogen has been described as being provided to the liquid cryogen atomizing nozzle 25 to cool the vapor space 22 before liquid cryogen is permitted to flow from the liquid cryogen supply line 32 through the bottom fill line 62 and into the pool of liquid cryogen 64, it will be understood that the freezer supply control valve 50 and the bottom fill control valve 60 may be opened simultaneously such that liquid cryogen simultaneously flows to the liquid cryogen atomizing nozzle 25 and the pool of liquid cryogen 64.

When a level of the pool of liquid cryogen 64 in the bottom space of the freezer 10 reaches a predetermined setpoint level (e.g., a high level setpoint) programmed into the controller 90, the controller 90 generates an output command which causes the bottom fill control valve 60 and the freezer supply control valve 50 to close, thereby preventing the flow of liquid cryogen from the supply of liquid cryogen 30 to the freezer 10. The liquid supply valve 34 will typically remain in an open position unless an overfill condition (e.g., a height above a preset maximum height) is sensed by the liquid level sensor 80. If the controller 90 determines that the pool of liquid cryogen 64 is in an overfill condition (e.g., the liquid level sensor 80 generates an output indicative of the level of the liquid cryogen 64 exceeding a preset maximum level), the controller 90 may be configured to generate an output indicative of the overfill condition. For example, the controller 90 may be configured to generate an alarm that alerts an operator to close the valve 34 and/or generates an output command that automatically closes the valve 34 (e.g., if the valve 34 is automated and in communication with the controller 90).

After the liquid level sensor 80 generates an output that the level of the pool of liquid cryogen 64 is within a desired range, such as above a preset minimum level and below a preset maximum level, the controller 90 may switch to the temperature control mode. The controller 90 may operate the freezer system 100 in temperature control mode until the level of the pool of liquid cryogen 64 sensed by the liquid level sensor 80 falls below the predetermined setpoint level (e.g., a low level setpoint) programmed into the controller 90, at which point the controller 90 will automatically switch back to level control mode.

If the controller 90 is in temperature control mode, the following refrigeration sequence will occur. When the temperature of the vapor space 22 sensed by the vapor space temperature sensor 70 is at or below a predetermined setpoint temperature (e.g., a high temperature setpoint), such as below the preset maximum temperature, the controller 90 may be configured to generate an output indicative of the freezer 10 being in normal operation. When the temperature of the vapor space 22 sensed by the vapor space temperature sensor 70 exceeds the predetermined setpoint temperature (e.g., the high temperature setpoint) programmed into the controller 90, the controller 90 may be configured to generate an output indicative of the vapor space 22 being too warm. In some embodiments, the controller 90 may be configured to then generate an output command which causes the gas bypass control valve 42 to open to direct the flow of cryogen from the liquid cryogen supply line 32 through the gas bypass line 40 to the atmosphere outside of the freezer 10. The gas bypass control valve 42 may remain open and the temperature measured by the gas bypass temperature sensor 44 may be provided to the controller 90 as input. When the temperature sensed by the gas bypass temperature sensor 44 is below a desired temperature, the controller 90 generates an output command causing the gas bypass control valve 42 to close and the freezer supply control valve 50 to open. For example, the controller 90 may cause the gas bypass control valve 42 to close and the freezer supply control valve 50 to open when a temperature measured by the gas bypass temperature sensor 44 is less the predetermined setpoint temperature programmed into the controller 90. Liquid cryogen may then flow from the liquid cryogen supply line 32 through the freezer supply line 52 to the liquid cryogen atomizing nozzle 25 and into the vapor space 22 above the storage space 20 in the freezer 10. In other embodiments, the controller 90 may generate an output command which causes the freezer supply control valve 50 to open without first venting liquid cryogen from the gas bypass control valve 42.

The vapor space temperature sensor 70 may continue to generate an output of the temperature sensed in the vapor space 22 which is provided to the controller 90 as an input. When the controller 90 determines that the temperature sensed by the vapor space temperature sensor 70 is at or below the high temperature setpoint, such as the minimum desired temperature of the vapor space 22 (e.g., low temperature setpoint), the controller 90 may generate an output command which causes the freezer supply control valve 50 to close, thereby preventing the flow of liquid cryogen from the supply of liquid cryogen 30 to the liquid cryogen atomizing nozzle 25 and into the vapor space 22 of the freezer 10.

The controller 90 may be configured such that at any time during the temperature control mode refrigeration sequence, if the temperature measured by the gas bypass temperature sensor 44 goes above the predetermined setpoint temperature (e.g., the high temperature setpoint) programmed into the controller 90 (and as measured by the vapor space temperature sensor 70), the controller 90 may generate an output command which causes the freezer supply control valve 50 to close and the gas bypass control valve 42 to open and thereby repeat the refrigeration sequence.

The liquid cryogen atomizing nozzle 25 may have a relatively low mass and have no trapped or stored volume of liquid cryogen such that the refrigeration or cooling of the freezer 10 will cease upon closing of the freezer supply control valve 50. Furthermore, rapid starting and stopping of the refrigeration sequence may be possible by cycling the freezer supply control valve 50. The rapid cycling may allow for very precise temperature control, such as less than 3° C. variation, such as less than 1° C. variation, of the freezer 10. Accordingly, the one or more samples 24 contained in the storage space 20 may avoid the temperature cycling that is present in conventional freezers.

In some embodiments, the controller 90 may be configured to operate without the second mode of operation (e.g., without the level control mode) and may operate in only the first mode of operation (e.g., the temperature control mode). For example, the controller 90 may be configured to operate in the temperature control mode when the freezer 10 does not require a pool of liquid cryogen 64 in the bottom space of the inner vessel 12, such as when the freezer 10 is configured to operate at higher freezer temperatures, such as at −80° C. or higher.

In some embodiments, the controller 90 may be configured to operate the freezer 10 in level control mode only. In this mode of operation, the controller 90 is configured to maintain the level of the pool of liquid cryogen 64, such as within the predetermined minimum and maximum levels, by determining sensed values and generating output commands to control the operations of the gas bypass control valve 42 and the bottom fill control valve 60 in the system, as described above. For example, the controller 90 may generate output commands which cause the bottom fill control valve 60 to open and close to control the flow of cryogen through the bottom fill line 62 such that the height of the pool of liquid cryogen 64 is maintained at a desired level or within a desired range. In this mode of operation, the freezer 10 may rely on conduction and convection to maintain a constant temperature (e.g., a setpoint temperature) in the freezer 10. Such mode of operation is generally the most efficient from a liquid cryogen usage standpoint. Level control mode is particularly useful in long term storage applications where the freezer 10 is seldom opened, such as to add or remove samples 24.

In some embodiments, the controller 90 may be configured to operate the freezer system 100 in a combined mode where both the level control mode and the temperature control mode are enabled. In the combined mode, the controller 90 may be configured to maintain a temperature of the vapor space 22 that is a few degrees above the boiling point of the liquid cryogen (e.g., liquid nitrogen) by generating command outputs which control the operation of the liquid cryogen atomizing nozzle 25, as described above. The combined mode of operation is particularly useful for working freezers to minimize temperature cycling of the contents when the freezer 10 is regularly opened and closed, such as by a user to add and/or remove samples 24.

In some embodiments, the controller 90 may also be configured to operate the freezer system 100 in temperature control mode only. In certain aspects, when the freezer system 100 is operated in temperature control mode only, the freezer 10 may not include a pool of liquid cryogen 64 in the bottom space of the inner vessel 12 of the freezer 10. In the temperature control mode, the controller 90 may be configured to maintain a temperature within the freezer 10, such as within the vapor space 22, that is well above the boiling point of the cryogen (e.g., above −80° C.) by generating command outputs which control the operations of the gas bypass control valve 42 and the freezer supply control valve 50, as described above. In embodiments which include a bottom fill control valve 60 and a bottom fill line 62, the bottom fill control valve 60 may be maintained in the closed position such that cryogen does not flow from the bottom fill line 62 to the inner vessel 12. The temperature control mode of operation is particularly useful for short term storage of biological materials or for storing biological materials that are sensitive to cryogenic temperatures (e.g., −90° C. and lower).

In some embodiments, the controller 90 may be configured to detect various operation conditions utilizing input received from the gas bypass temperature sensor 44, the vapor space temperature sensor 70, and/or the liquid level sensor 80 and to generate one or more outputs, such as generate appropriate alarms, generate notifications, or generate output commands to mitigate such conditions. Exemplary conditions include, but are not limited to, an over-fill condition, an under-fill condition, liquid supply empty condition, temperature out-of-range condition, freezer boiloff, and so forth.

In certain aspects, a large cryogenic supply system may include a supply of liquid cryogen 30 that contains thousands of gallons, such as between about 1,000 gallons and about 50,000 gallons, of liquid cryogen. In certain aspects, the liquid cryogen supply line 32 may be a vacuum jacketed line that is hundreds of feet (e.g., 100 feet to 900 feet) long that branches off to supply liquid cryogen to multiple freezers. As with all materials that retain cryogenic liquid, the heat leak into the vacuum jacketed liquid cryogen supply line 32 may cause the liquid cryogen within to boil to vapor. In large systems this can cause problems because as the distance between the supply of liquid cryogen 30 and the freezer increases, more vapor will be present in the liquid cryogen supply line 32. If liquid cryogen is needed at a freezer 10, it can take several minutes to hours to vent the accumulated cryogenic vapor present in the liquid cryogen supply line 32 before liquid cryogen can be delivered through the liquid cryogen supply line 32. To resolve this problem, most large cryogenic supply systems incorporate automatic cryogenic vents at the ends of the liquid supply line or its branches to vent the accumulated vapor in the liquid supply line to the atmosphere and keep the liquid supply line full of liquid cryogen. Because half of the refrigeration energy in warming the cryogen from a liquid state to a room temperature (e.g., 20° C. to 25° C.) vapor occurs while warming the vapor itself, automatic vents waste this available refrigeration by venting the vapors to the atmosphere. In some embodiments, the freezer system 100 may include multiple freezers 10 coupled with the supply of liquid cryogen 30 to utilize the refrigerant more efficiently, such as described below.

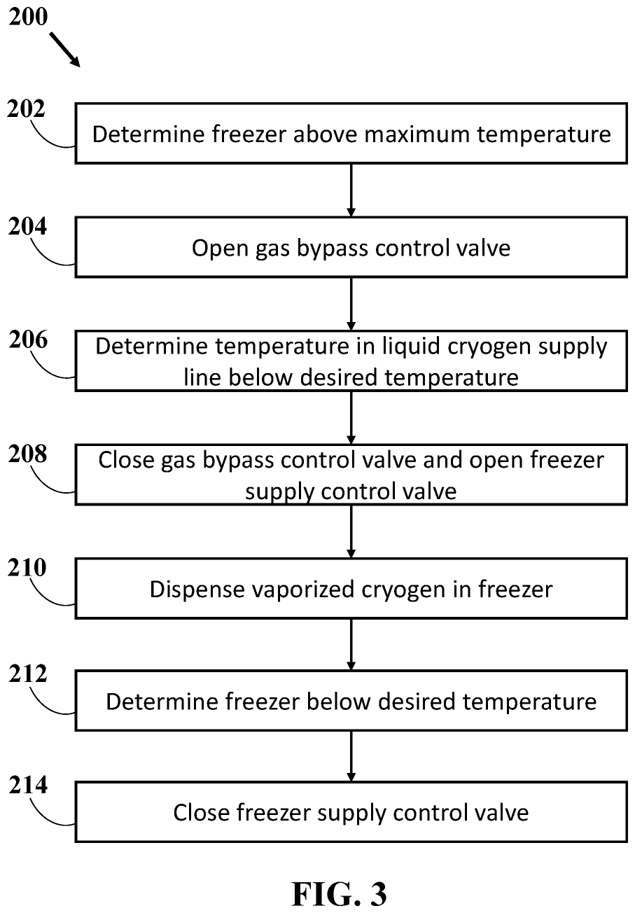

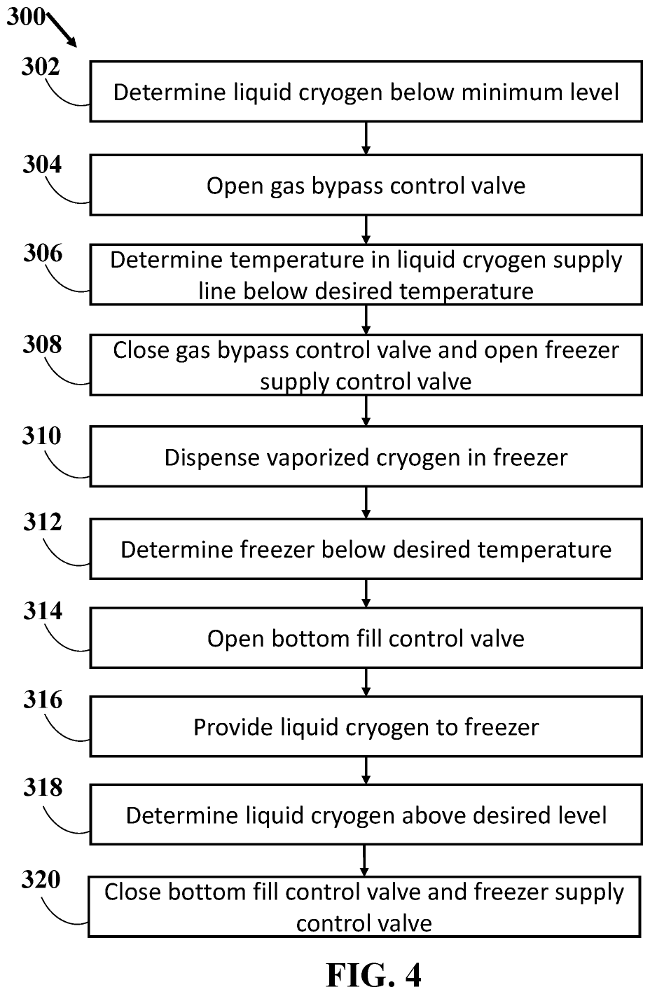

FIGS. 3-4 illustrate exemplary methodologies relating to controlling a freezer in a freezer system. While the methodologies are shown as being a series of acts that are performed in a sequence, it is to be understood and appreciated that the methodologies are not limited by the order of the sequence. For example, some acts can occur concurrently with another act. Further, in some instances, not all acts may be required to implement a methodology described herein.

With reference to FIG. 3, a flow diagram is provided illustrating a methodology 200 for controlling a temperature in a freezer. At step 202, a temperature of the freezer, such as an inner vessel or vapor space temperature, is determined to be above a maximum temperature. The temperature in the freezer may be sensed by a vapor space temperature sensor disposed in the freezer. As described above, a controller may be configured to receive the temperature sensed by the vapor space temperature sensor as an input and determine whether the temperature of the freezer is above or below a maximum temperature, such as a maximum temperature preset by a user.

At step 204, if the temperature of the freezer exceeds the maximum temperature, a gas bypass control valve may optionally be opened. Opening the gas bypass control valve may allow cryogen from a supply of liquid cryogen to flow through a liquid cryogen supply line into a gas bypass line. The cryogen may flow out of the gas bypass line, through the gas bypass control valve, and to the atmosphere. Venting the cryogen into the atmosphere may allow the cryogen in the supply of liquid cryogen and/or the liquid cryogen supply line to cool. As described above, the controller may be configured to generate an output command causing the gas bypass control valve to open. In some embodiments, step 204 may be omitted.

At step 206, the temperature in the liquid cryogen supply line may optionally be determined to be below a desired temperature. The temperature in the liquid cryogen supply line may be sensed by a gas bypass temperature sensor disposed in or coupled with the liquid cryogen supply line. In other embodiments, the temperature of the gas bypass line may be sensed. As described above, the controller may be configured to receive the temperature sensed by the gas bypass temperature sensor and determine whether the temperature of the cryogen supply is below a desired temperature, such as below a minimum temperature preset by a user or the temperature of the freezer. In some embodiments, step 206 may be omitted.

At step 208, if the temperature of the cryogen is determined to be below a desired temperature, the gas bypass control valve may optionally be closed and a freezer supply control valve may be opened. The desired temperature may be the minimum temperature preset by the user and programmed into the controller. Closing the gas bypass control valve and opening the freezer supply control valve may allow cryogen from the supply of liquid cryogen to flow through the liquid cryogen supply line into a freezer supply line and to a liquid cryogen atomizing nozzle positioned in the vapor space of the freezer. As described above, the controller may be configured to receive the temperature sensed by the vapor space temperature sensor as an input and determine whether the temperature of the freezer is below the desired temperature, such as a present minimum/maximum temperature preset by a user. In some embodiments, such as embodiments in which steps 204 and 206 are omitted, the gas bypass control valve may already be closed such that the freezer supply control valve is opened after step 202. For example, when a temperature of the freezer is determined to be above a maximum temperature, steps 204 and 206 may be omitted and the methodology 200 may continue with the opening of the freezer supply control valve without determining that the temperature of the cryogen is below a desired temperature.

At step 210, vaporized cryogen is disposed into the freezer from the liquid cryogen atomizing nozzle. The cryogen may be dispensed from the liquid cryogen atomizing nozzle as a flow of atomized liquid cryogen that vaporizes within the vapor space, thereby cooling the vapor space and/or the freezer. As described above, the controller may be configured to generate an output command causing the gas bypass control valve to close and the freezer supply control valve to open.

At step 212, the temperature in the freezer, such as in the inner vessel or vapor space, is determined to be below a desired temperature. The temperature may be sensed by the vapor space temperature sensor.

At step 214, if the temperature in the freezer is below the desired temperature, the freezer supply control valve is closed. As described above, the controller may be configured to generate an output command which closes the freezer supply control valve.

With reference to FIG. 4, a flow diagram is provided illustrating a methodology 300 for controlling a level of liquid cryogen in a freezer. At step 302, a level of liquid cryogen in the freezer is determined to be below a minimum level. The level of the liquid cryogen in the freezer may be sensed by a liquid level sensor. As described above, a controller may be configured to receive the cryogen level sensed by the liquid level sensor as an input and determine whether the level of liquid cryogen is above or below a minimum level, such as a minimum level preset by a user.

At step 304, if the level of the liquid cryogen is below the minimum level, a gas bypass control valve may optionally be opened. Opening the gas bypass control valve may allow cryogen from a supply of liquid cryogen to flow through a liquid cryogen supply line into a gas bypass line. The cryogen may flow out of the gas bypass line, through the gas bypass control valve, and to the atmosphere. Venting the cryogen into the atmosphere may allow the cryogen in the supply of liquid cryogen and/or the liquid cryogen supply line to cool. As described above, the controller may be configured to generate an output command causing the gas bypass control valve to open. In some embodiments, step 304 may be omitted.

At step 306, the temperature in the liquid cryogen supply line may optionally be determined to be below a desired temperature. The temperature in the liquid cryogen supply line may be sensed by a gas bypass temperature sensor disposed in or coupled with the liquid cryogen supply line. In other embodiments, the temperature of the gas bypass line may be sensed. As described above, the controller may be configured to receive the temperature sensed by the gas bypass temperature sensor and determine whether the temperature of the cryogen supply is below a desired temperature, such as below a minimum temperature preset by a user or the temperature of the freezer. In some embodiments, step 306 may be omitted.

At step 308, if the temperature of the cryogen is determined to be below a desired temperature, the gas bypass control valve may optionally be closed and a freezer supply control valve may be opened. The desired temperature may be the minimum temperature preset by the user and programmed into the controller. Closing the gas bypass control valve and opening the freezer supply control valve may allow cryogen from the supply of liquid cryogen to flow through the liquid cryogen supply line into a freezer supply line and to a liquid cryogen atomizing nozzle positioned in the vapor space of the freezer. As described above, the controller may be configured to receive the temperature sensed by the vapor space temperature sensor as an input and determine whether the temperature of the freezer is below the desired temperature, such as a present minimum/maximum temperature preset by a user. In some embodiments, such as embodiments in which steps 304 and 306 are omitted, the gas bypass control valve may already be closed such that the freezer supply control valve is opened after step 302. For example, when the level of liquid cryogen in the freezer is determined to be below a minimum level, steps 304 and 306 may be omitted and the methodology 300 may continue with the opening of the freezer supply control valve without determining that the temperature of the cryogen is below a desired temperature.

At step 310, vaporized cryogen is dispensed into the freezer from the liquid cryogen atomizing nozzle. The cryogen may be dispensed from the liquid cryogen atomizing nozzle as a flow of atomized liquid cryogen that vaporizes within the vapor space, thereby cooling the vapor space and/or the freezer. As described above, the controller may be configured to generate an output command causing the gas bypass control valve to close and the freezer supply control valve to open.

At step 312, the temperature in the freezer, such as in the inner vessel or vapor space, is determined to be below a desired temperature. The temperature may be sensed by the vapor space temperature sensor. As described above, the controller may be configured to receive the temperature sensed by the vapor space temperature sensor as an input and determine whether the temperature of the freezer is below the desired temperature, such as a present minimum/maximum temperature preset by a user.

At step 314, if the temperature in the freezer is below the desired temperature, a bottom fill control valve is opened. Opening the bottom fill control valve may allow some of the cryogen from the freezer supply line to flow into a bottom fill line into a bottom space of the inner vessel, which retains a pool of liquid cryogen. As described above, the controller may be configured to generate an output command which opens the bottom fill control valve. In some embodiments, the bottom fill control valve is opened simultaneously with opening the freezer supply control valve as described in step 310. For example, the freezer supply control valve and the bottom fill control valve may be opened simultaneously without the step of determining that the temperature in the freezer is determined to be below the desired temperature.

At step 316, liquid cryogen is provided to the freezer. Liquid cryogen may flow from the bottom fill line into the bottom space of the inner vessel. The flow of cryogen from the bottom fill line into the inner vessel may increase the level of liquid cryogen in the freezer.

At step 318, the level of liquid cryogen in the freezer is determined to be above a desired level. The level of liquid cryogen in the freezer may be sensed by the liquid level sensor. As described above, the controller may be configured to receive the cryogen level sensed by the liquid level sensor and determine whether the level of liquid cryogen is above a desired level, such as below a minimum level preset by a user.

At step 320, if the level of liquid cryogen in the freezer is determined to be above the desired level, the bottom fill control valve and the freezer supply control valve are closed. As described above, the controller may be configured to generate output commands which close the bottom fill control valve and the freezer supply control valve.

While the freezer supply control valve has been described as being opened before the bottom fill control valve, it will be understood that the methodology 300 may have other orders. For example, at step 308, when the temperature of the cryogen is determined to be below desired temperature, the bottom fill control valve may be opened first instead of the freezer supply control valve or both the bottom fill control valve and the freezer supply control valve may be opened substantially simultaneously. In embodiments where the bottom fill control valve is opened first, the freezer supply control valve may be subsequently opened or the step of opening the freezer supply control valve may be omitted. Additionally, the bottom fill control valve and the freezer supply control valve may be closed at different times. For example, the bottom fill control valve may be closed before the freezer supply control valve or the freezer supply control valve may be closed before the bottom fill control valve.

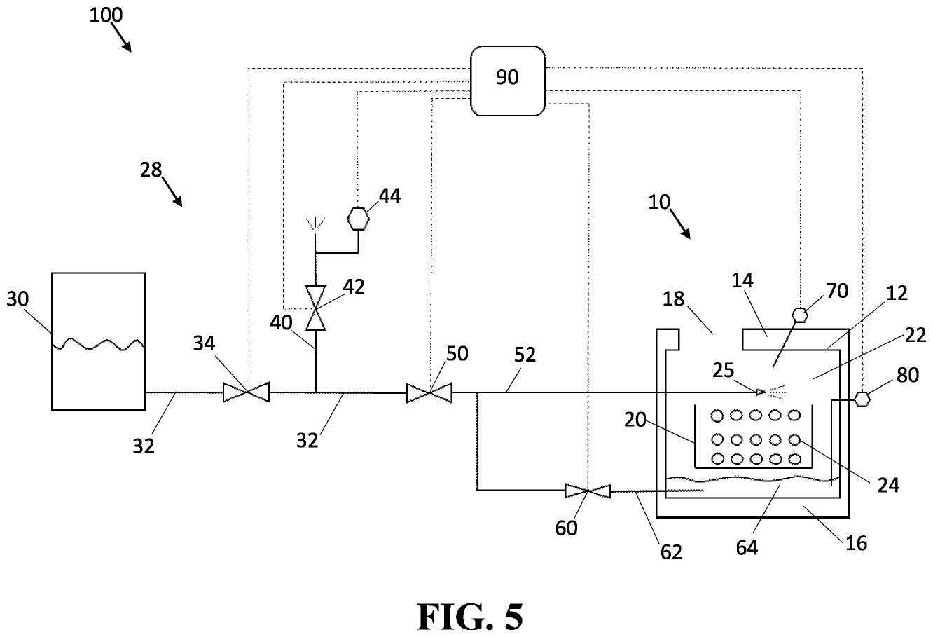

Referring now to FIG. 5, another freezer system 100 according to the present disclosure is illustrated. The freezer system 100 may be similar to the freezer system 100 described in FIGS. 1-4 with the difference that the bottom fill control valve 60 is disposed downstream of the freezer supply control valve 50. The freezer supply control valve 50 is connected to the liquid cryogen supply line 32 downstream of where the gas bypass line 40 is fluidly connected to the liquid cryogen supply line 32 and is configured to direct the flow of liquid cryogen to the freezer 10 via the freezer supply line 52. The freezer supply control valve 50 may be moved between a closed position in which liquid cryogen is prevented from flowing from the liquid cryogen supply line 32 to the freezer supply line 52 and an open position in which liquid cryogen may flow from the liquid cryogen supply line 32 to the freezer supply line 52. A downstream end of the freezer supply line 52 is fluidly connected to the liquid cryogen atomizing nozzle 25. Accordingly, when the liquid supply valve 34 and the freezer supply control valve 50 are in the open position and the gas bypass control valve 42 is in the closed position, liquid cryogen flows from the supply of liquid cryogen 30 through the liquid cryogen atomizing nozzle 25 into the vapor space 22 of the freezer 10, thereby cooling the vapor space 22.

The bottom fill control valve 60 is fluidly connected to the freezer supply line 52 and to a bottom fill line 62. The bottom fill line 62 is fluidly connected to the bottom space of the inner vessel 12, which retains the pool of liquid cryogen 64. The bottom fill control valve 60 may be moved between a closed position in which liquid cryogen is prevented from flowing from the freezer supply line 52 to the bottom fill line 62 and an open position in which liquid cryogen may flow from the freezer supply line 52 to the bottom fill line 62. Accordingly, when the liquid supply valve 34, the freezer supply control valve 50, and the bottom fill control valve 60 are in the open position and the gas bypass control valve 42 is in the closed position, liquid cryogen flows from the supply of liquid cryogen 30 through the bottom fill line 62 into the bottom space of the freezer 10 and through the liquid cryogen atomizing nozzle 25 into the vapor space 22 of the freezer 10, thereby cooling the freezer 10 via the pool of liquid cryogen 64 in the bottom space of the inner vessel 12 as well as via the atomized liquid cryogen that is injected into the vapor space 22. The freezer system 100 may be operated in the temperature control mode, the level control mode, or both the temperature and level control modes, as described above.

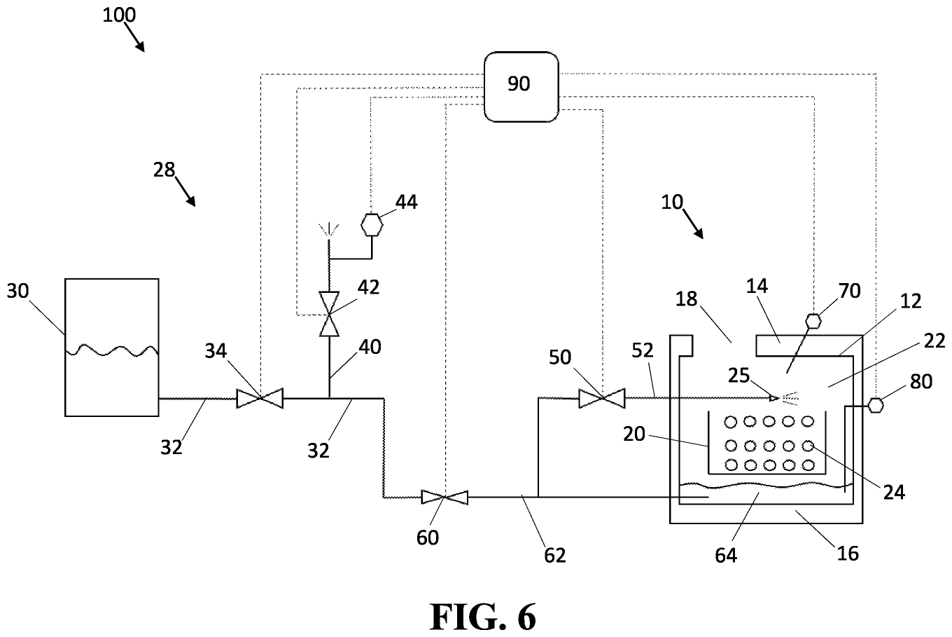

Referring now to FIG. 6, another freezer system 100 according to the present disclosure is illustrated. The freezer system 100 may be similar to the freezer system 100 described in FIGS. 1-4 with the difference that the freezer supply control valve 50 is disposed downstream of the bottom fill control valve 60. The bottom fill control valve 60 is connected to the liquid cryogen supply line 32 downstream of where the gas bypass line 40 is fluidly connected to the liquid cryogen supply line 32 and is configured to direct the flow of liquid cryogen to the pool of liquid cryogen 64 via the bottom fill line 62. The bottom fill control valve 60 may be moved between a closed position in which liquid cryogen is prevented from flowing from the liquid cryogen supply line 32 to the bottom fill line 62 and an open position in which liquid cryogen may flow from the liquid cryogen supply line 32 to the bottom fill line 62. Accordingly, when the liquid supply valve 34 and the bottom fill control valve 60 are in the open position and the gas bypass control valve 42 is in the closed position, liquid cryogen flows from the supply of liquid cryogen 30 through bottom fill line 62 and into the bottom space of the freezer 10 thereby cooling the freezer 10 via the pool of liquid cryogen 64 in the bottom space of the inner vessel 12.

The freezer supply control valve 50 is fluidly connected to the bottom fill line 62 at an upstream end and the freezer supply line 52 and the downstream end. The downstream end of the freezer supply line 52 is fluidly connected to the liquid cryogen atomizing nozzle 25. The freezer supply control valve 50 may be moved between a closed position in which liquid cryogen is prevented from flowing from the bottom fill line 62 to the freezer supply line 52 and an open position in which liquid cryogen may flow from the bottom fill line 62 to the freezer supply line 52. Accordingly, when the liquid supply valve 34, the bottom fill control valve 60, and the freezer supply control valve 50 are in the open position and the gas bypass control valve 42 is in the closed position, liquid cryogen flows from the supply of liquid cryogen 30 through the bottom fill line 62 into the bottom space of the freezer 10 and through the liquid cryogen atomizing nozzle 25 into the vapor space 22 of the freezer 10, thereby cooling the freezer 10 via the pool of liquid cryogen 64 in the bottom space of the inner vessel 12 as well as via the atomized liquid cryogen that is injected into the vapor space 22. The freezer system 100 may be operated in the temperature control mode, the level control mode, or both the temperature and level control modes, as described above.

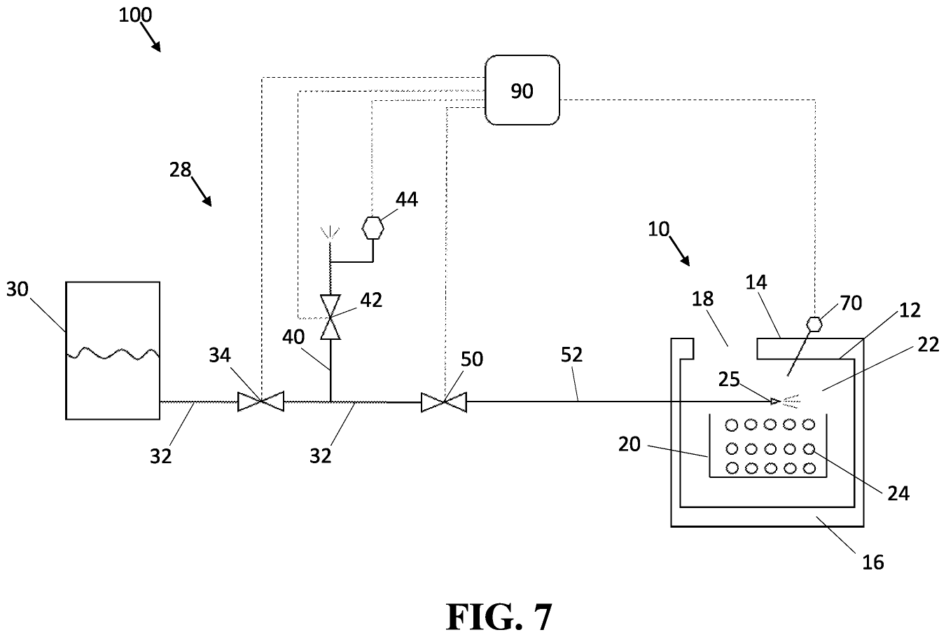

Referring now to FIG. 7, another freezer system 100 according to the present disclosure is illustrated. The freezer system 100 may be similar to the freezer system 100 described in FIGS. 1-4 with the difference that the bottom fill control valve, pool of liquid cryogen, and bottom fill line are omitted.

The freezer supply control valve 50 is fluidly connected to the liquid cryogen supply line 32 at an upstream end and is fluidly connected to a freezer supply line 52 at a downstream end. The freezer supply control valve 50 is connected to the liquid cryogen supply line 32 downstream of where the gas bypass line 40 is fluidly connected to the liquid cryogen supply line 32 and is configured to direct the flow of liquid cryogen to the freezer 10 via the freezer supply line 52. The downstream end of the freezer supply line 52 is directly connected to the liquid cryogen atomizing nozzle 25. The freezer supply control valve 50 may be moved between a closed position in which liquid cryogen is prevented from flowing from the liquid cryogen supply line 32 to the freezer supply line 52 and an open position in which liquid cryogen may flow from the liquid cryogen supply line 32 to the freezer supply line 52. Accordingly, when the liquid supply valve 34 and the freezer supply control valve 50 are in an open position and the gas bypass control valve 42 is in a closed position, liquid cryogen flows from the supply of liquid cryogen 30 through the liquid cryogen atomizing nozzle 25 into the vapor space 22 of the freezer 10, thereby cooling the vapor space 22. The freezer system 100 may be operated in the temperature control mode, as described above.

The freezer system 100 may be implemented as a standalone system for maintaining cold temperatures within the freezer 10 or the freezer system 100 may be implemented as part of a larger system. The freezer 10 of the freezer system 100 may be a cryogenic freezer and/or the freezer system 100 may be implemented with another freezer, such as a freezer that includes other mechanisms for cooling. For example, the freezer system 100 may be implemented with a high efficiency cryogenic freezer with a rotary carousel or with a high efficiency cryogenic freezer with a motorized carousel coupled with the controller, or the system 100 may be implemented as a cooling assist for a mechanical refrigeration freezer or system.

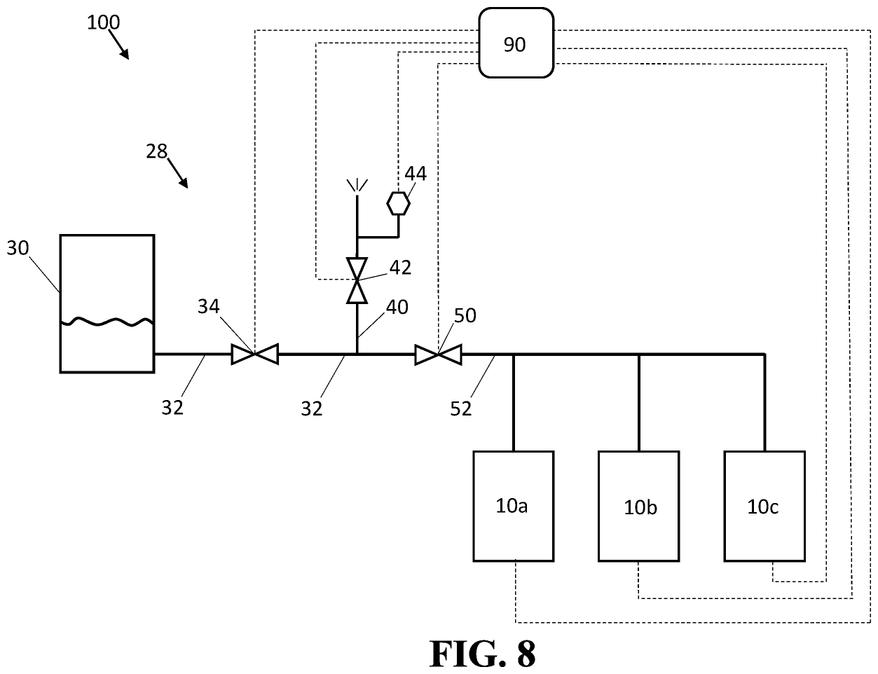

Referring now to FIG. 8, another freezer system 100 according to the present disclosure is illustrated. The freezer system 100 may be similar to the freezer systems 100 described in FIGS. 1-7 with the differences described as follows. The freezer system 100 includes a liquid cryogen supply system 28 that includes a supply of liquid cryogen 30 that is fluidly connected to a plurality of freezers, such as a first freezer 10a, a second freezer 10b, and a third freezer 10c. The freezers 10a, 10b, 10c may be similar to the freezer 10 described in FIG. 1, above, and include all the components described therein.

The supply of liquid cryogen 30 may be fluidly connected to each of the freezers 10a, 10b, 10c by a liquid cryogen supply line 32 and a freezer supply line 52. The supply system 28 may also include a liquid supply valve 34 positioned in or along the liquid cryogen supply line 32 to control the flow of liquid cryogen from the supply of liquid cryogen 30 to the freezers 10a, 10b, 10c. The liquid cryogen supply line 32 and the liquid supply valve 34 may be similar to the liquid cryogen supply line 32 and the liquid supply valve 34 described in FIG. 1. While not pictured, one or more of the freezers 10a, 10b, 10c may include a liquid cryogen atomizing nozzle operatively coupled with the freezer supply line 52 and one or more pools of liquid cryogen operatively coupled with the freezer supply line 52, such as described in FIG. 1. For example, each of the freezers 10a, 10b, 10c may include a liquid cryogen atomizing nozzle and a pool of liquid cryogen, each operatively coupled with the freezer supply line 52.

The freezer system 100 also includes a gas bypass line 40 that is fluidly connected to the liquid cryogen supply line 32 and a gas bypass control valve 42 positioned in or along the gas bypass line 40 that is configured to optionally vent warm gas to the atmosphere. The system 100 also includes a gas bypass temperature sensor 44 that is in communication with the liquid cryogen supply line 32 and positioned downstream of the gas bypass control valve 42 and upstream of the freezer supply control valve 50. The gas bypass temperature sensor 44 senses the temperature of the liquid cryogen within the liquid cryogen supply line 32 at a point of the freezer supply line 52 and the bottom fill line 62. The gas bypass line 40, gas bypass control valve 42, and gas bypass temperature sensor 44 may be similar to the gas bypass line 40, gas bypass control valve 42, and gas bypass temperature sensor 44 described in FIG. 1, respectively. While the gas bypass temperature sensor 44 has been described as being downstream of the gas bypass control valve 42, it will be understood that the gas bypass temperature sensor 44 may be positioned upstream of the gas bypass control valve 42 and/or the gas bypass line 40 such that it may sense the temperature of the liquid cryogen within the liquid cryogen supply line 32 at a point upstream of the freezer supply line 52 and the bottom fill line 62.

The freezer system 100 also includes a freezer supply control valve 50 that is fluidly connected to the liquid cryogen supply line 32 and the freezer supply line 52. The freezer supply control valve 50 may be similar to the freezer supply control valve 50 described in FIG. 1. While the illustrated embodiment includes one freezer supply control valve 50, it will be understood that the freezer system 100 may include any number of freezer supply control valves 50. For example, the freezer system 100 may include a freezer system 100 may include a freezer supply control valve 50 disposed along the freezer supply line 52 upstream of each of the freezers 10a, 10b, 10c.

While not pictured, the freezer system 100 may also include one or more bottom fill lines, one or more bottom fill control valves, one or more vapor space temperature sensors, and one or more liquid level sensors. For example, each of the freezers 10a, 10b, 10c may include a pool of liquid cryogen operatively coupled with a bottom fill line via a bottom fill control valve, a vapor space temperature sensor, and a liquid level sensor. The bottom fill control valves may be disposed downstream of, upstream of, or in parallel with respect to the one or more freezer supply control valves 50, such as described with respect to FIGS. 1, 5, and 6.

Each of the valves and sensors may be in communication with a controller 90. The controller 90 may be similar to the controller 90 described in FIGS. 1-2. For example, the controller 90 may be configured to receive the outputs of each of the sensors as input and may be configured to control the operations (e.g., positions) of the valves via output commands. The controller 90 may operate as described above in FIGS. 1-4.

The freezers 10a, 10b, 10c may be positioned along the freezer supply line 52 to receive cryogen to cool and/or maintain the temperature of the freezer 10a, 10b, 10c, such as via a liquid cryogen atomizing nozzle and/or bottom fill line, as described above. The freezers 10a, 10b, 10c may be positioned along the freezer supply line 52 based upon desired operating temperatures. The freezers 10a, 10b, 10c may be positioned along the freezer supply line 52 with freezers 10a, 10b, 10c having a lower desired operating temperature placed closed to the supply of liquid cryogen 30 and freezers 10a, 10b, 10c having a higher desired operating temperature placed farther from the supply of liquid cryogen 30. For example, a desired operating temperature of freezer 10a may be lower than a desired operating temperature of freezer 10b and the desired operating temperature of freezer 10b may be lower than a desired operating temperature of freezer 10c. As such, the colder cryogen in the liquid cryogen supply line 32 can be used more efficiently and may also operate as a vent to keep the liquid cryogen supply line 32 and/or the freezer supply line 52 full of liquid cryogen. For example, the cryogen in the liquid cryogen supply line 32 and/or the freezer supply line 52 may warm as it travels farther from the supply of liquid cryogen 30. In some embodiments, the freezers 10a, 10b, 10c placed farthest from the supply of liquid cryogen may have a desired operating temperature above the temperature of the cryogen.

In the illustrated embodiment, the freezer system 100 includes three freezers 10a, 10b, 10c. However, it will be understood that the freezer system 100 may include any number of freezers. For example, the freezer system 100 may include two or four or more freezers.

By positioning and configuring freezers operating at temperatures well above the temperature of the cryogen (e.g., above −80° C.) proximate to the ends of the liquid cryogen supply line branches (e.g., farthest from the supply of liquid cryogen 30), the cold vapor present in the liquid cryogen supply line can be utilized to refrigerate the freezer and also serve as an automatic vent to keep the remainder of the liquid cryogen supply line full of liquid cryogen.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

While various inventive aspects, concepts and features may be described and illustrated herein in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present disclosure. Still further, while various alternative embodiments as to the various inventive aspects, concepts and features—such as alternative materials, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present disclosure even if such embodiments are not expressly disclosed herein. Additionally, even though some inventive aspects, concepts, or features may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, descriptions of exemplary methods or processes are not limited to inclusion of all steps as being required in all cases, nor is the order that the steps are presented to be construed as required or necessary unless expressly so stated or the context dictates otherwise.

1-43. (canceled)

44. A cryogenic freezer system comprising:
a liquid cryogen supply system comprising:
a supply of liquid cryogen; and
a freezer supply control valve;
a freezer comprising:
an inner vessel defining a storage space and a vapor space;
an outer shell that surrounds and is separated from the inner vessel to define an insulation space between the outer shell and the inner vessel; and
a liquid cryogen atomizing nozzle positioned within the vapor space and configured to receive a flow of liquid cryogen and to produce a flow of atomized liquid cryogen that vaporizes within the vapor space to thereby cooling the vapor space;
wherein the freezer supply control valve is configured to operatively control a flow of liquid cryogen to the liquid cryogen atomizing nozzle.

45. The freezer system of claim 44, further comprising a bottom fill control valve configured to operatively control a flow of liquid cryogen to a bottom portion of the inner vessel.

46. The freezer system of claim 45, wherein the bottom fill control valve is disposed in parallel with the freezer supply control valve.

47. The freezer system of claim 45, further comprising a controller configured to control a level of liquid cryogen in the bottom portion of the inner vessel.

48. The freezer system of claim 44, further comprising a controller configured to control the flow of liquid cryogen to the liquid cryogen atomizing nozzle.

49. The freezer system of claim 44, further comprising a gas bypass control valve configured to vent warm gas to an atmosphere upstream from the freezer supply control valve.

50. The freezer system of claim 44, further comprising a second freezer.

51. A freezer system comprising:
a liquid cryogen supply system comprising:
a supply of liquid cryogen; and
a freezer supply control valve;
a freezer comprising:
an inner vessel defining a storage space and a vapor space;
an outer shell that surrounds and is separated from the inner vessel to define an insulation space between the outer shell and the inner vessel; and
a liquid cryogen atomizing nozzle positioned within the vapor space and configured to receive a flow of liquid cryogen and to produce a flow of atomized liquid cryogen that vaporizes within the vapor space to thereby cooling the vapor space; and
a controller with a freezer control system having programmed instructions configured to operate the freezer supply control valve to control a temperature in the vapor space;
wherein the freezer supply control valve is configured to operatively control a flow of liquid cryogen to the liquid cryogen atomizing nozzle.

52. The freezer system of claim 51, wherein the liquid cryogen supply system further comprises a gas bypass control valve configured to vent warm gas to an atmosphere.

53. The freezer system of claim 51, wherein the freezer control system includes programmed instructions configured to operate the gas bypass control valve.

54. The freezer system of claim 51, further comprising a bottom fill configured to operatively control a flow of liquid cryogen to a bottom portion of the freezer.

55. The freezer system of claim 54, wherein the freezer control system of the controller includes programmed instructions configured to operate the bottom fill control valve to control of a level of liquid cryogen in the bottom portion of the freezer.

56. The freezer system of claim 55, wherein the controller includes programmed instructions to control the level of liquid cryogen in the freezer before controlling the temperature of the vapor space.

57. The freezer system of claim 51, further comprising a second freezer.

58. A method performed by a controller of a freezer system, the method comprising:
generating an output indicative of a vapor space of a freezer exceeding a maximum temperature;
opening a freezer supply control valve;
dispensing cryogen into the vapor space of the freezer via a liquid cryogen atomizing nozzle; and
determining a temperature of the vapor space being below the desired temperature.

59. The method of claim 58, further comprising the steps of:
opening a gas bypass control valve;
determining a temperature of a liquid cryogen supply line to be below a predetermined temperature; and
closing the gas bypass control valve.

60. The method of claim 58, further comprising the step of opening a bottom fill control valve to provide liquid cryogen to the freezer.

61. The method of claim 60, further comprising the steps of generating an output indicative of the liquid cryogen in the freezer being above a predetermined level and closing the bottom fill control valve.

62. The method of claim 58, wherein the temperature of the vapor space is sensed by a vapor space temperature sensor.

63. The method of claim 48, further comprising the steps of generating an output indicative the temperature of the vapor space being below the desired temperature and closing the bottom fill control valve.
